(19) United States
(12) Patent Application Publication
(10) Pub. No.: US 2014/0089093 A1
(43) Pub. Date: Mar. 27, 2014

(54) Contextual Communication Management System and Method

(71) Applicant: Carl Christopher Tierney, Dallas, TX (US)

(72) Inventor: Carl Christopher Tierney, Dallas, TX (US)

(21) Appl. No.: 14/035,346

(22) Filed: Sep. 24, 2013

Related U.S. Application Data
(60) Provisional application No. 61/704,779, filed on Sep. 24, 2012.

(51) Int. Cl. G06Q 30/02

(52) U.S. Cl. CPC G06Q 30/0267; G06Q 30/0273; G06Q 30/0261
USPC 705/14.58; 705/14.69; 705/14.64

(57) ABSTRACT

A contextual communication management system/method that coordinates the dissemination of information to/from a mobile communication device (MCD) and the associated mobile communication user (MCU) is disclosed. The system/method allows the state context of a given MCD and its MCU to be used to direct communications with the MCD based on a wide variety of state parameters including but not limited to current geospatial location, geospatial path, path chronology, third party geo-temporal leaseholds, etc. In some preferred embodiments this contextual communication permits targeted advertising to be “pushed” to a MCD in response to a function of the real-time geospatial location and current/past known states of the MCU. A Leasehold Management Coordinator (LMC) permits targeted bi-directional third-party interactions with the MCD based on advertising “leases” of virtual MCD geo-space/time and associated MCU state/context pools.

This disclosure is a non-provisional conversion of, and thus claims priority to, U.S. Provisional Patent Application No. 61/704,779, filed Sep. 24, 2012, the entirety of which is incorporated herein by reference.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### FIELD OF THE INVENTION

The present invention relates generally to systems and methods that control communication between two communicating entities (e.g., a Communication Master (COM) and a Communication Slave (COS)) based on contextual state matching rules that are continually applied to the COM and/or COS communicators.

Application of the present invention in some preferred embodiments may relate to a variety systems and methods associated with consumer advertising. While not limitive of the teachings of the present invention, a typical application for this technology is in the field of tracking the status of a Mobile Communication User (MCU) with respect to a wide variety of state variables (both past and present) and using this information to control advertising communications to/from the Mobile Communication Device (MCD) associated with the MCU. This exemplary capability has application in PUSH advertising to a given MCD based on a wide variety of MCU state variables and the provides the ability to “lease” virtual advertising space associated with arbitrary algebraic combinations of state space variables associated with MCD/MCU pairings.

### PRIOR ART AND BACKGROUND OF THE INVENTION

### Prior Art

The integration of Internet communications and a wide variety of mobile communication devices has spawned a number of applications which attempt to customize advertising to a particular individual based on their association with a given retail store or location. For example, technology now exists to perform facial recognition of an individual as they enter a restaurant/retail establishment and then trigger an advertising communication to the individual using the individual's association with a social media website. Other methodologies exist to transmit periodic advertising to individuals based on e-mail contact lists, etc.

What is lacking within all of these methodologies is a more coordinated way to “lease” virtual advertising based on the contextual “state” of the message recipient. For example, there is no current method of performing targeted advertising to mobile devices based on a detailed analysis of the current and previous states of the users associated with the mobile devices. An advertiser who wishes to advertise specifically to mobile users in close physical/temporal proximity to their retail establishment has no viable methodology of implementing this type of advertising. For example, a restaurant wishing to target sports fans leaving a sporting arena after a game cannot perform this type of targeted advertising using current Internet advertising technologies. Furthermore, broadcast forms of advertising over the Internet are regularly discarded as “spam” and as such generally ineffective at targeting potential customers for any given advertiser.

### Deficiencies in the Prior Art

The prior art as detailed above suffers from the following deficiencies:
Internet advertising to mobile devices is generally in the form of e-mail that must be manually read by the Mobile Communication User (MCU).
Current Internet advertising is generally oblivious to the state context of the advertising recipient.
Current PUSH advertising technologies lack state input from the message recipient to determine if the advertising to be pushed is indeed appropriate for the recipient given their current and prior state.
Current advertising methodologies are state-blind to any prior state or state-path traversed by the MCU in the past. This means that some types of advertising are impossible to accurately target without knowledge of what the user/consumer has experienced in the past.

While some of the prior art may teach some solutions to several of these problems, the core issues of integrating COM/COS communication with knowledge of the contextual state of the COM/COS user has not been addressed by the prior art.

### OBJECTIVES OF THE INVENTION

Accordingly, the objectives of the present invention are (among others) to circumvent the deficiencies in the prior art and affect the following objectives:
(1) Provide for a contextual communication management system and method that allows a Communication Master (COM) to communicate with a Communication Slave (COS) based on the state of the COM and/or COS.
(2) Provide for a contextual communication management system and method that permits contextual communication between a COM and COS based on an algebraic combination of COM/COS state variables.
(3) Provide for a contextual communication management system and method that provides a methodology for PUSH advertising that is sensitive to the message recipient's geographic location and/or temporal state.
(4) Provide for a contextual communication management system and method that permits bidirectional contextual communication between a COM and COS.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention may be generally described as a bidirectional communication system/method that triggers communication between a Communication Master (COM) and a Communication Slave (COS) based on matching functions contained in a Leasehold State Match Criterion Database (LMCD) that contains arbitrarily complex state matching criterion expressed as one or more algebraic matching functions. State information from the COM and/or COS is stored and compared with the LMCD and if a match is found, a communication event is triggered between the COM and the COS. In this manner, communication between the COM/COS pair is driven by the combined context of the two entities rather than based on unitary state information only known by the COM. In many preferred embodiments, a Leasehold Management Coordinator (LMC) coordinates the COM/COS communications and is responsible for the collection and analysis of COM/COS state data as well as the creation and maintenance of the LMCD. This permits the LMC to arbitrate and sell virtual advertising “leases” to COM advertisers who wish to advertise and communicate with COS customer users using a context-driven communication paradigm.

A present invention preferred embodiment describes a system and method for facilitating “leased” advertising that targets a customer defined “state space” environment. In a preferred exemplary embodiment, rather than indiscriminately broadcast advertising simultaneously to many customers, the present invention permits customers to register with a Leasehold Management Coordinator (LMC) that then monitors the state of a mobile communication user (MCU) via a mobile communication device (MCD). The “state” of the MCU can include a wide variety of state parameters, including but not limited to geographic location, travel speed, proximity to retail establishments, shopping history, interaction with previous advertising, chronological time, etc.

In a preferred exemplary embodiment, each of these state variables may be combined in an arithmetic expression with other state variables to form a matching function that when satisfied permits a lessee of selected advertising state space the opportunity to specifically target the MCU with PUSH advertising copy selected from an advertising database. In this manner the lessee of the advertising state space may only target MCUs that are likely to engage in a purchasing decision with respect to the lessee advertiser.

### BRIEF DESCRIPTION OF THE DRAWINGS

For a fuller understanding of the advantages provided by the invention, reference should be made to the following detailed description together with the accompanying drawings wherein:

FIG. 1 illustrates a preferred exemplary system embodiment of the present invention;

FIG. 2 illustrates a preferred exemplary method embodiment of the present invention;

FIG. 3 illustrates a preferred exemplary system embodiment of the present invention as implemented in a PUSH advertising application;

FIG. 4 illustrates a preferred exemplary method embodiment of the present invention as implemented in a PUSH advertising application;

FIG. 5 illustrates a detailed example of a preferred exemplary system embodiment of the present invention as implemented in a PUSH advertising application;

FIG. 6 illustrates a preferred exemplary system embodiment of the present invention as implemented in an application where PUSH advertising is implemented using a software application deployed to the MCD;

FIG. 7 illustrates a typical division of virtual advertising space that may be useful in some preferred embodiments of the present invention;

FIG. 8 illustrates a typical shared division of virtual advertising space that may be useful in some preferred embodiments of the present invention;

FIG. 9 illustrates a preferred exemplary system embodiment of the present invention incorporating triggered deployment of in-store shopping assistance applications to the MCD;

FIG. 10 illustrates a preferred exemplary system embodiment of the present invention incorporating automated store register checkout;

FIG. 11 illustrates a preferred exemplary system embodiment of the present invention incorporating real-time targeted PUSHed advertising content delivery;

FIG. 12 illustrates a preferred exemplary method embodiment of the present invention incorporating real-time targeted PUSHed advertising content delivery;

FIG. 13 illustrates a preferred exemplary system embodiment of the present invention incorporating competitive PUSHed advertising content delivery;

FIG. 14 illustrates a preferred exemplary method embodiment of the present invention incorporating competitive PUSHed advertising content delivery;

FIG. 15 illustrates how state trees within the leasehold state match criterion database may be compared with historical COM-COS states;

FIG. 16 illustrates a preferred exemplary method embodiment of the present invention implementing a leasehold state match criterion comparison method.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a CONTEXTUAL COMMUNICATION MANAGEMENT SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Internet Communication not Limitive

The present invention anticipates that a wide range of communication methodologies may be utilized to affect a specific implementation of the present invention. While the present invention specifically anticipates that the use of the Internet for most applications, the present invention makes no limitation on the type of communication technology or computer networking that may be used. Thus, the terms “communication network”, “computer network”, and/or “Internet” are to be given the broadest possible definitions within the scope of the present invention.

### State Tracking Processor (STP) not Limitive

The present invention in some preferred embodiments utilizes a state tracking processor (STP) to gather state information about a MCD and/or MCU and track the state of the MCD/MCU pair over time. This data gathering entity is thought to be optimally implemented as a real-time application (“AP”) within the MCD, but may take the form of a polled application or remotely triggered software module.

### Mobile Communication Device (MCD) not Limitive

The present invention anticipates that many types of computerized mobile communication devices (MCDs) may be used by mobile communication users (MCUs) to receive and interact with Targeted Advertising Data (TAD) directed at the MCUs by various subsystems within the present invention. Thus the term “MCD” and its variants should be given its broadest possible interpretation that includes but is not limited to a mobile phone, smartphone, tablet computer, laptop computer, automobile computers and computing devices, and the like.

### Master/Slave not Limiting

The present invention may in some preferred embodiments utilize the terms “master”/“Communicating Master (COM)” and “slave”/“Communicating Slave (COS)” to describe various communicating entities in various system contexts. These terms may in some circumstanced be interchangeable with the communication flowing symmetrically between the master and slave. For example, in some preferred system contexts the Communication Master (COM) is a business entity that opts to “push” advertising to a Communication Slave (COS) based on the state of user associated with the COS and any history of the COS/user. However, equivalently in some circumstances the COS may be configured to “push” solicitations to the COM under a variety of state conditions. For example, a COS may broadcast an “offer” to purchase an “ice cream cone” within a mall that he/she may be visiting if the price matches a certain value.

Other “offers” may include non-geocentric requests to “quote a 22 cubic foot refrigerator in Dallas, Tex.” or other more general offers that may be matched to a variety of business establishments within the “Dallas, Tex.” local or outside this area.

Therefore, the COM/COS structure described herein may be implemented in a variety of symmetric ways such that the terms “master” and “slave” should be given a broad interpretation consistent with the application context of the invention.

### MCU Interaction as State Variable not Limitive

The concept of “state” as it applies to the MCD and any coupled MCU is anticipated to incorporate the possibility of MCU interaction with the MCD. This interaction may take the form of unprompted queries by the MCU and/or prompt/response interactions between the MCD and MCU. For example, unprompted queries by the MCU to the MCD for information (e.g., “Where can I find a greeting card store in the mall?”) or MCU responses to MCD prompts initiated by the LSM (e.g., a MCD prompt “Do you want a greeting card to go with that Christmas gift you just purchased?” with a MCU response of “Yes”; “Its lunchtime! Your favorite burger is now on sale at the food court! Interested in this discount?” with a MCU response of “I'd rather have a salad”).

The present invention anticipates that the mechanism of interaction between the MCU and the MCD supporting this state variable can be implemented using text as well as speech. In this context, the present invention anticipates that the PUSH ad processor (PAP) described herein may incorporate a speech interpretation module that enables both PUSHing of vocal advertising copy to the MCU, but also interaction with the MCU to permit state variables to be defined in terms of unprompted queries as well as prompt/response interactions. Thus, the present invention makes no limitation on the type of MCU interaction that can constitute the basis of a MCU state variable.

### State Groups not Limitive

The present invention describes in various embodiments a variety of “state groups” that may be used to define the current state of a COM and/or COS in various contexts (either individually or in a plethora of combinations). These state groups are generally listed herein as follows:
GEOGRAPHIC—these states deal with the physical location of the COS/COM;
CHRONOLOGICAL—these states are time related, whether using calendars or other more granular methods, and may include custom calendar definitions;
TRAVEL—these states involve the travel path characteristics of the COS, such as speed, direction, travel path, etc.;
HISTORY—these states involve historical patterns of the COS, and may include things such as purchasing patterns, etc. or any other historical data on COS activity or state transitions;
ENVIRONMENTAL—these states involve the physical environment, and may include such elements as the weather, ambient temperature, etc.;
CLUSTER—these states involve interactions with clusters or aggregations of COM and/or COS entities;
RESPONSE—these states involve responses by a user to some form of prompting by a COS or COM;
INQUIRY—these states involve inquiries by a user to a COM or COS;
PURCHASE—these states involve purchases by a user that trigger the potential for other state events;
EVENT—these states involve external events that are customized to trigger state action; and
PROFILE—these states involve known profile information about the COM/COS user, such as identifying information, customer preferences, privacy settings, etc.

One skilled in the art will recognize that this list is non-exhaustive and can be readily modified and/or expanded to accommodate a wide variety of application specific implementations of the present invention.

### State History not Limitive

The present invention specifically anticipates that states may have “history” that can be linked to form path-directed and non-path directed chains. For example a non-path directed history might involve the purchase of a given item from “any” retailer in the area within the last year. In contrast, a path-directed history might include a limitation of a specific purchase from a specific store in the last week preceded by a purchase from another store prior to this purchasing event.

In this manner, any state described herein may have a historical path associated with it that may be considered an atomic state for the purpose of state matching. Thus, state paths and state tree paths may be used as atomic elements within any state-based matching methodology described herein, and thus the term “state” should be broadly construed to include state paths and combinations of state paths that form state path trees.

### Bifurcated State Response not Limitive

Within some preferred embodiments of the present invention the MCU may provide feedback responses to information presented on the MCD. This feedback information may be in response to a bifurcated state response testing scenario in which the MCU is presented with two or more possible options (products, advertisements, etc.) and asked to select the option that is preferable to the MCU. This response characteristic can then be quantified as a MCU state that can then be used to trigger targeted advertising for the MCU.

### Lessor/Lessee not Limitive

The present invention anticipates that in some preferred embodiments a “virtual advertising space” may be defined in which states associated with COM and/or COS entities is “leased” to lessees by lessors controlling and/or managing the “virtual advertising space.” It should be noted that as with real property, the virtual leasehold leased by the lessor to the lessee may potentially be “sub-let” by the lessee to a tertiary lessee (if the virtual leasehold permits sub-letting), with this sub-letting process continued to any level of nesting. In this sub-letting context, an original lessor becomes the lessee to the tertiary lessee. Thus, the terms “lessor” and “lessee” should be viewed in this context and given a broad interpretation based on this anticipated application context of the present invention.

As with conventional real estate, a lessee only has a property interest in the “domain” of the leased property, and can only sub-let within the confines of this domain. Therefore, as the sub-letting process continues, the domain scope of possible leaseholds may diminish within the context of the various state domains. For example, a master lessee may lease virtual advertising space to a shopping mall which may then sub-lease virtual advertising space within its geographic location to individual retail establishments in the shopping mall. This may be further constrained by time such that certain stores lease PUSH advertising during some portion of the day but not others. Other forms of “leases” involving “shared occupancy” are also anticipated within this application context that permit common use of a virtual advertising leasehold by several lessees.

### Advertise/Geolocation not Limitive

The present invention anticipates a wide variety of application environments. In many application contexts, a MCU/MCD geolocation will be used as a state space variable to trigger PUSH advertising to the MCD that is linked to an advertiser positioned at or near that geolocation. For example, a given retail store might wish to advertise to potential customers as they pass the store while walking through a shopping mall. However, competitive advertising may also be sold in this state space, wherein a competitor of the retail establishment advertises in that particular geolocation state space and promotes a competitive store or product. Furthermore, related products not directly supplied or endorsed by the retailer may be advertised within this state space.

### Geolocation not Limitive

Within the context of the present invention, the terms “GPS”, “geolocation”, “location”, “position”, and the like should be broadly interpreted to incorporate both a planar mapping coordinates (longitude, latitude, etc.) as well as altitude. “Altitude” may also be interpreted to include “shelf height” within a particular retail establishment (whether absolute or relative to the “floor” of the store) and may include the structure level of a multi-story building or store. Thus, the concept of “location” should be broadly interpreted when determining the scope of the present invention.

### Advertising Rates not Limitive

The potentially competitive advertising characteristic of the present invention permits auctioning of virtual advertising space to occur wherein the state space surrounding a particular geolocation (or other state space combination) can be sold to the highest bidder. In this manner a state space combination may be sold at a fixed price or a price that is competitively arrived at by the marketplace.

Furthermore, the advertising rate may be adjusted based on any sale made by the advertiser as a result of the advertising. For example, a base advertising rate may apply to distribute the targeted state space advertisement, an additional charge may be applied if this triggers a store visit, and yet another charge may be applied should the consumer actually purchase a product from the advertising retailer.

Advertising rates may also vary based on the geographic location over which the advertising is promoted. For example, rates may be higher for state spaces that encompass areas farther from a retailer's central location.

### System Overview (0100)

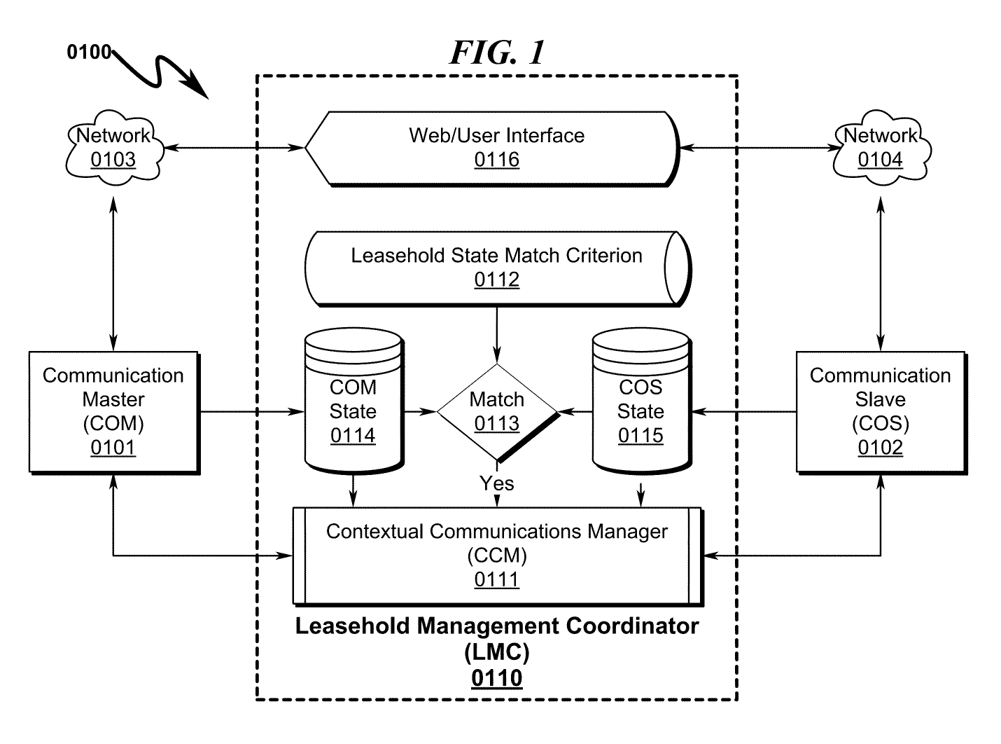

The present invention in a system embodiment may be broadly described as depicted in FIG. 1 (0100) wherein context-based communications is managed between a Communication Master (COM) (0101) and a Communication Slave (COS) (0102) through a Leasehold Management Coordinator (LMC) (0110). The LMC incorporates a Contextual Communications Manager (CCM) (0111) that manages communications between the COM (0101) and the COS (0102) based on a Leasehold State Match Criterion Database (LMCD) (0112). When information within the LMCD (0112) matches (0113) state information gathered on the COM (0101) and stored in the COM state database (0114) and/or state information gathered on the COS (0102) and stored in the COS state database (0115), the CCM (0111) links the COM (0101) and the COS (0102) to form a communication bridge in which both of these communication entities may communicate based on information defined by the COM (0101) and the COS (0102). A web/user interface (0116) permits the COM (0101) and the COS (0102) to interact with the LMC (0110) through one or more computer networks (0103, 0104) to configure communication characteristics and other operational criterion under which the LMC (0110) operates.

As an exemplary application, the system as depicted might be used in a situation where a number of businesses interacting with computerized COM entities wish to interact with COS devices in the form of Mobile Communication Devices (MCDs) operated by Mobile Communication Users (MCUs). In this context, advertising from the businesses can be targeted towards specific MCUs based on leased “state space” criterion maintained in the leasehold state space match criterion database (0112). The state space criterion matches the current state of the COM (0101) and/or COS (0102) to the LMCD (0112) and may permit advertising and other forms of targeted communication to flow between the COM (0101) and COS (0102). This targeted communication may take many forms based on the current state of the COM (0101) and/or COS (0102), and may include geographic, calendar, event, cluster, and other forms of targeted state-based advertising communications described herein. Note that the COM (0101) and/or COS (0102) state databases (0114, 0115) may be used by the COM (0101) and/or COS (0102) entities in various applications to gather and collate information regarding behavior patterns of the COM (0101) and/or COS (0102). For example, the COM (0101) may inspect the COS state database (0115) to determine purchasing patterns, patterns of geographic shopping, seasonal purchasing patterns, etc.

### Method Overview (0200)

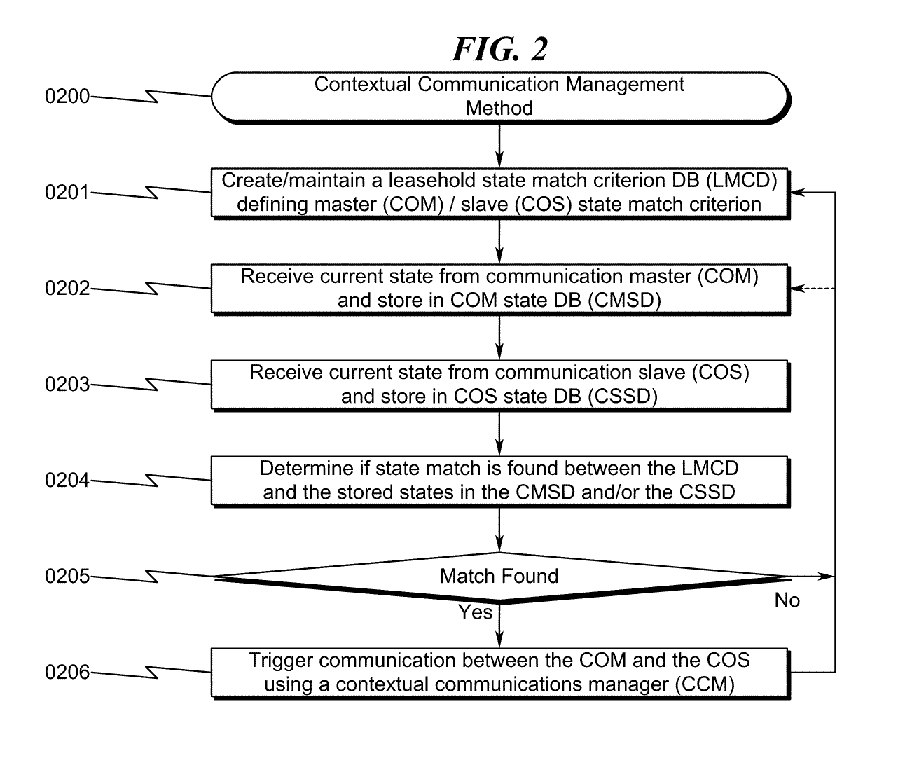

The present invention in a method embodiment may be generally described by the flowchart of FIG. 2 (0200), wherein the contextual communication management method comprises the following steps:
(1) creating and maintaining a Leasehold State Match Criterion Database (LMCD) that defines matching criterion for state references associated with a Communication Master (COM) and a Communication Slave (COS) (0201);
(2) receiving current state information from a Communication Master (COM) and storing this current COM state information in a COM state database (CMSD) (0202);
(3) receiving current state information from a Communication Slave (COS) and storing this current COS state information in a COS state database (CSSD) (0203);
(4) determining if there is a state match found between the matching criterion state references found in the LMCD and the stored states in the CMSD and/or CSSD (0204);
(5) if a state match is not found, proceeding to step (1) or optionally step (2) (0205);
(6) triggering a communication event between the COM and the COS using a Contextual Communications Manager (CCM) and proceeding to step (1) or optionally step (2) (0206);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Note that within this exemplary method embodiment one preferred alternative allows optional recursion to step (2) (0202). Yet another method variant uses PUSH advertising from the COM to the COS as part of the triggered communication in step (6) (0206).

### Application to Gifting and Serving

While not limitive of the scope of the invention, some preferred invention embodiments may have wide application within charitable non-profit gifting and serving contexts. For example, MCD/MCU pairs that are in geographic proximity to service projects may be solicited via PUSH advertising to participate in these projects or aid those in participation. Non-profit organizations may use this as a means of targeted advertising to organize personnel and/or financial gifting resources to support specific charitable functions and/or serve the community in very specific ways. Characteristics associated with the MCU such as skills, availability, favorite charities, and the like may be used to target these individuals for integration into group efforts sponsored by a coordinating charity or other non-profit organization.

MCU profiles may be state-matched to organizational efforts in this manner. For example, the MCU profile for JOHN SMITH might indicate “skilled carpenter” and “free weekends”, the combination of which may match an advertising promotion for “house remodel for elderly couple this Saturday” or the like.

### Exemplary State Definition Grammar

The present invention anticipates that the MCD and associated MCU “states” that may be matched using the teachings of the present invention may encompass a wide variety of state variables and other considerations. While only exemplary of a possible state definition grammar, the following sections depict the use of an Extended Backus-Naur Form (EBNF) definition for the state context that may be useful in understanding the capabilities of this analysis function.

The goal of this grammar definition is to support a methodology of describing MCU “state spaces” which may be leased to allow context-based communication between a communications master (COM) and communications slave (COS).

Some random examples of this state expression format as applied to some textual examples of state space mapping might include the following:
Walking MCUs from ages 20-30 within 100 yards of THE HOME DEPOT in Lewisville Tex. on SATURDAY and SUNDAY in the SPRING on non-rainy days.
MCDs that visited LOEWS home improvement in Denton, Tex. within the last week but spent less than 10 minutes in the store.
Walking MCUs within 50 yards of any of JOE'S ICE CREAM franchises when the local ambient temperature is over 100 degrees.
MCUs shopping in the WILLOW BEND shopping mall but not ANDROID® phone users.
   One skilled in the art will recognize that the textual examples provided above can be reduced to algebraic equivalent statements using algebraic operator primitives as described below.

As can be seen from these textual examples, the leased state space may contain a wide variety of conditions that are keyed to MCU/MCD state information that is relayed to the Leasehold Management Coordinator (LMC). Advertisers and other entities may opt to “lease” the advertising state space and thus gain access to the MCU via the LMC once the state space conditions are met.

### Define Primitive Operators

The following BNF syntax depicts a variety of operator primitives that may be used in conjunction with various state variables.

| | | |
|---|---|---|
| <nil> | ← | <> |
| <logical-conjunction> | ← | + |
| <logical-disjunction> | ← | * |
| <logical-XOR> | ← | ! |
| <logical-negation> | ← | ~ |
| <op-unary> | ← | <logical-negation> |
| <op-bin> | ← | <logical-conjunction> |

| | |
|---|---|
| \| | <logical-disjunction> |
| \| | <logical-XOR> |

While other functional operators may be incorporated into this basic set, this functionality permits states to be algebraically combined to form a wide variety of “state spaces” that may be “leased” to advertisers under a wide variety of conditions.

Define Basic State Expression Formats

The following BNF syntax defines how state expressions may be combined to form complex state analysis structures that divide the total possible state space into a state space leasehold. Note that these expressions may be algebraically combined to any level of complexity or nesting depth.

| | | |
|---|---|---|
| <state-exp> | ← | <state-var> |

| | |
|---|---|
| \| | <op-unary> <state-exp> |
| \| | <state-exp> <op-bin> <state-exp> |
| \| | ( <state-exp> ) |

Define Basic State Variable Types

The following BNF syntax depicts how state variables may be defined within the state space. This exemplary embodiment incorporates the following state variable types:
GEOGRAPHIC—these state variables sense the physical geographic position of the MCD as it relates to an absolute geographic position, its distance from some reference point (retail establishment, etc.), its position within or distance from a specific geographic area, or its previous travel path.
CHRONOLOGICAL/TIME—these state variables sense the current time associated with the MCD, and may include ranges of chronological time, seasons, or portions thereof
TRAVEL—these state variables sense the status of the MCU travel, such as speed, direction, path, etc.
ENVIRONMENT—these state variables sense the environment in which the MCD is contexted. For example, this might include the current weather conditions, ambient temperature, humidity, lighting, etc.
ECONOMIC—these state variables sense the economic state of the MCU. For example, this might include the estimated annual income of the MCU, amount of purchases this day/week/month, etc.
CLUSTER—these state variables sense “clusters” of selected MCDs and/or MCUs to enable “aggregations” of targeted customers to be specifically addressed. For example, a group might consist of “all iPhone® users” or “all Android® users” or “clusters under age 30 larger in number than 10.”
INQUIRY—these state variables sense inquiries by the MCU to the MCD.
RESPONSE—these state variables sense responses by the MCU to prompts by the MCD.
PROFILE—these state variables define profile characteristics of the MCD and/or MCU.
PURCHASE—these state variables sense purchases by the MCU that may relate to other states.
EVENT—these state variables sense event statuses that may be sensed by the system or asynchronously triggered based on user-defined event stimuli.
   One skilled in the art will recognize that this list is non-exhaustive and only exemplary of the types of state variables possible using the teachings of the present invention.

| | | |
|---|---|---|
| <state-var> | ← | <geo-state> |

| | |
|---|---|
| \| | <time-state> |
| \| | <travel-state> |
| \| | <environment-state> |
| \| | <economic-state> |
| \| | <cluster-state> |
| \| | <inquiry-state> |
| \| | <response-state> |
| \| | <profile-state> |
| \| | <purchase-state> |
| \| | <event-state> |

### Define Geographic States

The following BNF syntax depicts how geographic states may be defined within the state space. This exemplary embodiment incorporates the ability to broadly define geography in terms of absolute GPS coordinates, distance to a particular GPS location, area, or reference (business, retail establishment, restaurant, etc.).

Note that geographic areas may be defined in terms of three or more GPS coordinates (longitude, latitude, altitude) that define a geographic area boundary as well as distances from a fixed GPS coordinate. Other common geographic identifiers may be utilized, such as ZIP code, AREA CODE, CITY, COUNTY, STATE, etc. This geographic state definition specifically anticipates that retail establishments may be defined in terms of a “shorthand” notation that describes the location in terms of a known identifier, such as “THE HOME DEPOT in Lewisville, Tex. on Acme Road”.

| | | |
|---|---|---|
| <geo-state> | ← | <gps-shorthand> |

| | |
|---|---|
| \| | <gps-location> |
| \| | <gps-distance> |
| \| | <gps-area> |
| \| | <gps-path> |

| | | |
|---|---|---|
| <gps-shorthand> | ← | <business identifier> |

| | |
|---|---|
| \| | <street address> |
| \| | <city> |
| \| | <state> |
| \| | <ZIP> |

| | | |
|---|---|---|
| <gps-location> | ← | <longitude>, <latitude> |

[, <altitude>]

| | |
|---|---|
| <gps-distance> | ← <distance-function> |

((gps-location), (gps-location))

| | |
|---|---|
| <gps-triangle> | ← <gps-location> |

<gps-location>
<gps-location>

| <gps-ZIP> | ← <digit><digit><digit><digit><digit> | |
|---|---|---|
| <gps-area> | ← | <gps-triangle> |

| | |
|---|---|
| \| | <gps-ZIP> |
| \| | <gps-area> <gps-location>] |

| | |
|---|---|
| <gps-path> | ← [<gps-path>,] <gps-location> |

### Define Time States

The following BNF syntax depicts how time states may be defined within the state space. This exemplary embodiment incorporates the ability to broadly define time in terms of both absolute calendar/clock time (e.g., “3 PM on 5-JAN-2013”) as well as relative time (e.g., “all SATURDAYS in SPRING”). Any of these time states may be incorporated into a time range (e.g., “MON-THR 15:00-16:00”).

| | | |
|---|---|---|
| <time-state> | ← | [<date>] [<time>] |

| | |
|---|---|
| \| | <time-range> |
| \| | <time-block> |
| \| | <time-state> |

| | | |
|---|---|---|
| <date> | ← | <month>/<day>/<year> |
| <time> | ← | <HH>:<MM>:<SS> |
| <time-range> | ← | <time> - <time> |
| <time-block> | ← | <year> |

| | |
|---|---|
| \| | <season-of-year> |
| \| | <month-of-year> |
| \| | <week-of-month> |
| \| | <day-of-week> |
| \| | <holiday-of-year> |
| \| | <portion-of-day> |
| \| | <meal-of-day> |
| \| | <hour-of-day> |
| \| | <time-of-day> |

| | | |
|---|---|---|
| <digit> | ← | 0 \| 1 \| 2 \| 3 \| 4 |

| | |
|---|---|
| \| | 5 \| 6 \| 7 \| 8 \| 9 |

| | | |
|---|---|---|
| <year> | ← | <2012>.. |
| <month> | ← | <01>..<12> |
| <day> | ← | <01>..<31> |
| <HH> | ← | <00>..<23> |
| <MM> | ← | <00>..<59> |
| <SS> | ← | <00>..<59> |
| <season-of-year> | ← | <SPRING> |

| | |
|---|---|
| \| | <SUMMER> |
| \| | <FALL> |
| \| | <WINTER> |

| | | |
|---|---|---|
| <holiday-of-year> | ← | <NEW YEARS> |

| | |
|---|---|
| \| | <PRESIDENTS DAY> |
| \| | <EASTER> |
| \| | <MEMORIAL DAY> |
| \| | <INDEPENDENCE DAY> |
| \| | <LABOR DAY> |
| \| | <COLUMBUS DAY> |
| \| | <THANKSGIVING> |
| \| | <CHRISTMAS> |

| | | |
|---|---|---|
| <month-of-year> | ← | <JAN> \| <FEB> \| <MAR> |

| | |
|---|---|
| \| | <APR> \| <MAY> \| <JUN> |
| \| | <JUL> \| <AUG> \| <SEP> |
| \| | <OCT> \| <NOV> \| <DEC> |

| | | |
|---|---|---|
| <day-of-week> | ← | <SUN> \| <MON> \| <TUE> |

| | |
|---|---|
| \| | <WED> \| <THR> \| <FRI> |
| \| | <SAT> |

| | | |
|---|---|---|
| <portion-of-day> | ← | <DAY> \| <MORNING> \| <NOON> |

| | |
|---|---|
| \| | <AFTERNOON> \| <EVENING> \| <NIGHT> |

| | | |
|---|---|---|
| <meal-of-day> | ← | <BREAKFAST> \| <BRUNCH> |

| | |
|---|---|
| \| | <LUNCH> \| <DINNER> |

### State Definition GUI

The present invention anticipates that a graphical user interface (GUI) may be used by advertisers to define state triggers based on state grammars as exemplified above. Thus, advertisers may utilize a textual description for the advertising states they wish to lease from the LMC, or they may utilize a GUI to place icons within a graphical workspace to define the specific advertising space they wish to lease and under what conditions the lease space is to be activated. This GUI may also incorporate support for defining the PUSH advertising to be associated with the leasehold space and other application development tools associated with in-store shopping support applications and the like.

### Exemplary PUSH Advertising System Embodiment (0300)

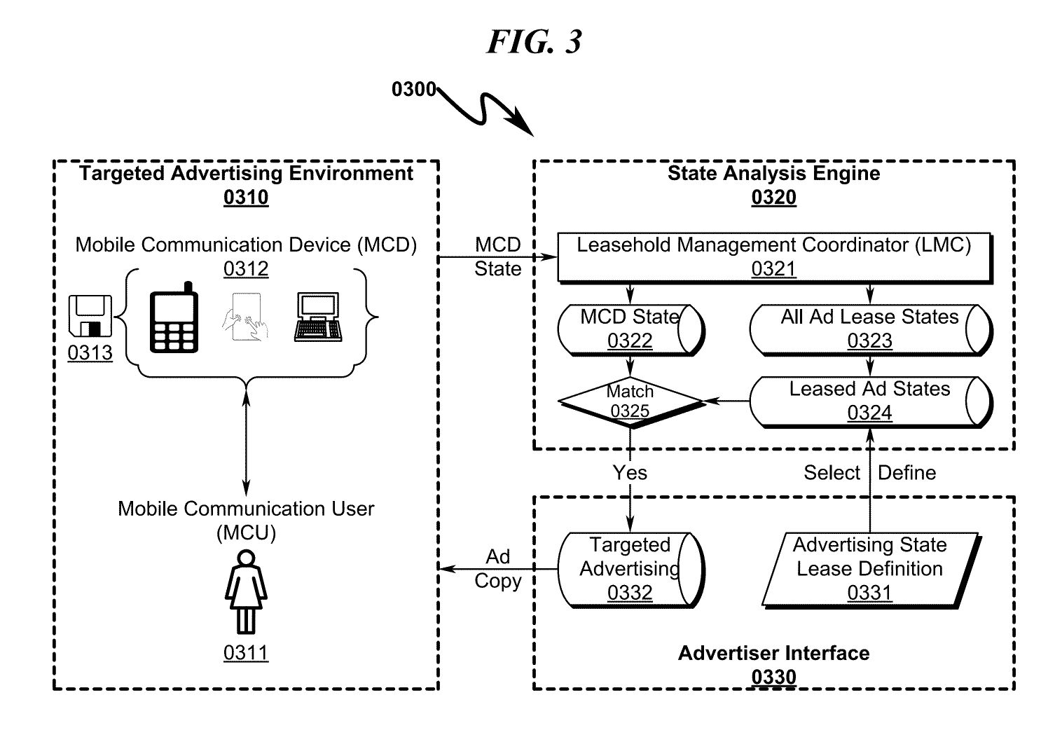

The present invention may be advantageously applied to a mobile targeted advertising application as generally illustrated in FIG. 3 (0300). In this exemplary system, a Targeted Advertising Environment (0310) comprising a Mobile Communication User (0311) interacting with a Mobile Communication Device (MCD) (0312) running under control of software read from a computer readable medium (0313) interacts with a state analysis engine (0320) by providing current MCU/MCD state information to a Leasehold Management Coordinator (LMC) (0321). This state information is stored in a state database (0322). Available advertising states stored in a database (0323) are filtered to produce a set of leased advertising states (0324) in response to advertising “leases” that are entered/purchased (0331) by retail advertisers or the like using an advertising interface (0330). These leased advertising states (0324) are then matched (0325) to the state database (0322) and if a match is determined to be found, targeted advertising (0332) is directed as advertising copy to the targeted advertising environment (0310) based on the leasehold definition purchased (0331) by the advertiser via the advertising interface (0330).

### Exemplary PUSH Advertising Method Embodiment (0400)

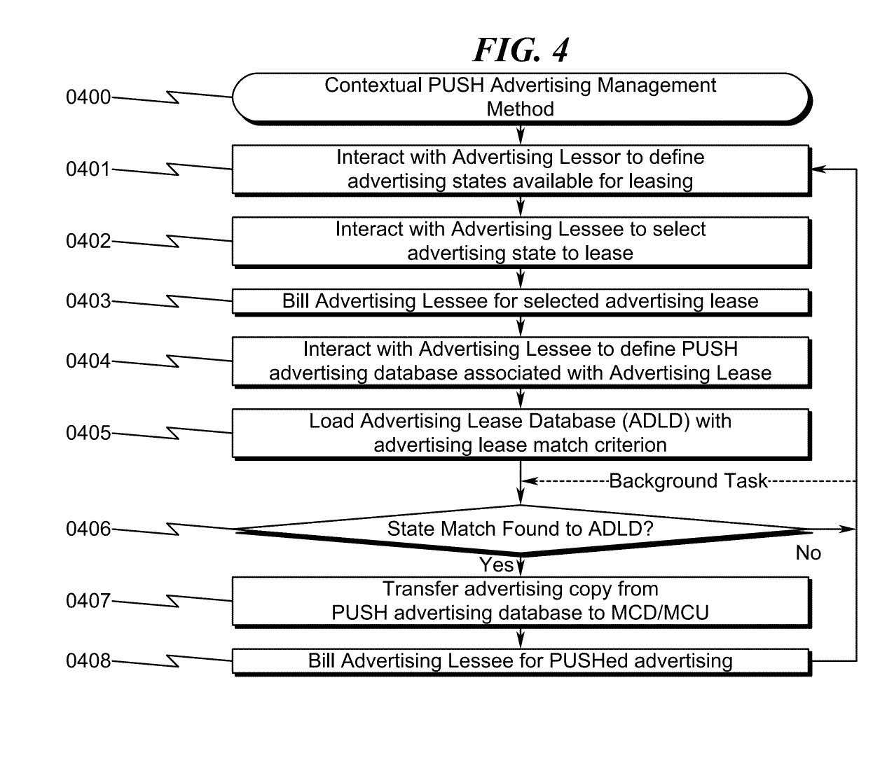

The present invention in a method embodiment applied to PUSH advertising may be generally described by the flowchart of FIG. 4 (0400), wherein the contextual communication management method comprises the following steps:
(1) Accepting input from and advertising lessor to define advertising states available for leasing (0401);
(2) Accepting input from an advertising lessee to select advertising states to lease (0402);
(3) Billing the advertising lessee for the selected advertising states (0403);
(4) Accepting input from the advertising lessee to define a PUSH advertising database associated with the selected advertising lease (0404);
(5) Loading an advertising lease database with advertising lease match criterion (0405);
(6) If a state match is not found between the state of MCD/MCU and the advertising lease match criterion database, proceeding to step (6) or optionally to step (1) (0406);
(7) Transferring advertising copy from the PUSH advertising database to a MCD/MCU (0407); and
(8) Billing the advertising lessee for the PUSHed advertising (0408);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Note that within this exemplary method embodiment one preferred alternative allows optional background recursion to step (6) (0406) in the matching process, so that the contents of the advertising lease match database (ADLD) is continually matched to the state of potential MCD/MCU pairs.

### Exemplary PUSH Advertising System Detail (0500)

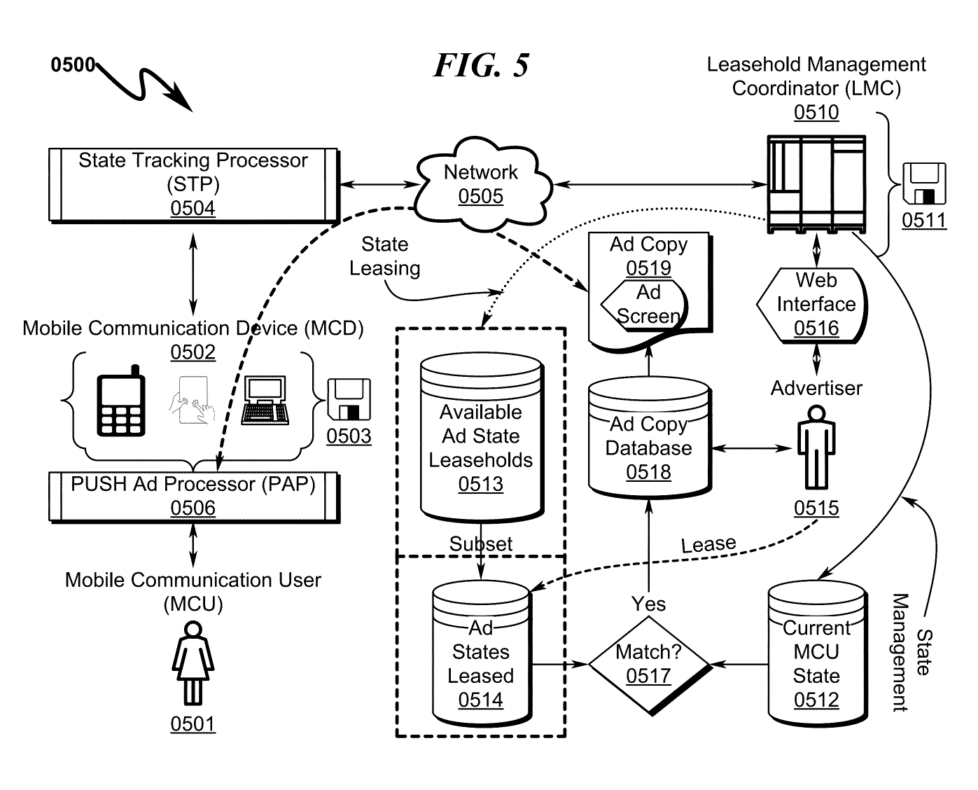

More detail of a PUSH advertising system embodiment is generally illustrated in FIG. 5 (0500). In this exemplary system, a Mobile Communication User (0501) interacts with a Mobile Communication Device (MCD) (0502) running under control of software read from a computer readable medium (0503) interacts with a state tracking processor (STP) (0504) by providing current MCU/MCD state information via a computer network (0505) (typically the Internet) to a Leasehold Management Coordinator (LMC) (0510) running under control of software read from a computer readable medium (0511). This state information is stored in a current MCU state database (0512).

Available advertising states stored in a database (0513) are filtered to produce a set of leased advertising states (0514) in response to advertising “leases” that are entered/purchased by retail advertisers (0515) or the like using an advertising interface (0516). These leased advertising states (0514) are then matched (0517) to the leased state database (0514) and if a match is determined to be found, targeted advertising extracted from an advertising copy database (0517) is directed as advertising copy (0518) to the targeted advertising environment in the form of a PUSH advertising processor (PAP) (0506) based on the leasehold definition purchased (0514) by the advertiser (0515) via the advertising interface (0516).

### Advertiser-Specific Communication Modules (0600)

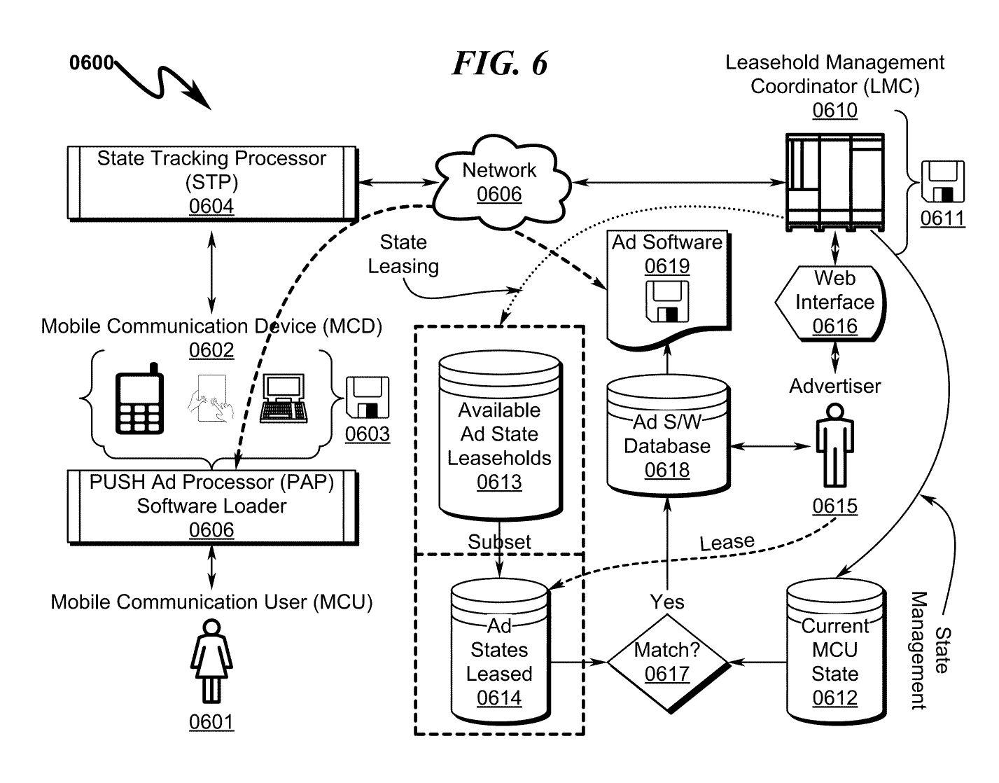

In certain system embodiments the advertising copy transmitted to the PUSH ad processor (PAP) may be more complex than simple advertising displays. As generally illustrated in FIG. 6 (0600), the concept of PUSH ad processing in the context of the present invention anticipates the integration of advertising software (0619) that is loaded onto the MCD (0602) via aid of a PUSH ad processor (PAP) software loader (0606). In this manner a wide variety of complex advertiser-MCU interactions may take place in which communication from the MCD (0602) to the LMC (0610) may take place to further refine the “state” of the MCU (0501).

Note that this software advertising system variant anticipates that the software (0619) downloaded from the ad software database (0618) may take the form of “native” software that may be directly executed by the MCD (0602), or it may take the form of “pseudo-code” or instructions that are interpreted (or compiled and then executed) by the PUSH ad processor (PAP) software loader (0606). Thus, even if the MCD does not permit remote loading of software via its loaded software applications, primitive software functions can be implemented within the PUSH ad processor (PAP) software loader (0606) and then invoked with commands from pseudo-code loaded from the advertising software database (0618) in the form of remotely loaded advertising application software (0619).

### Fracturing of Advertising State Space (0700)

The present invention permits the creation of advertising space “out of thin air” by permitting a given advertiser the ability to combine MCD/MCU states into algebraic combinations that may be used to define the exact context in which the advertising is to be applied to the MCU. Since the advertising “space” that is “leased” by the leasehold management coordinator (LMC) is “virtual”, it may contain arbitrarily combined states as exemplified by the sample state grammar definition given above. This means that advertising leases may be created “out of thin air” and also that additional constraints may be incorporated within a given state space to further narrow the scope of the “triggering” states to which advertiser ad copy will be distributed (or under which conditions an advertiser-specific communication module will be invoked).

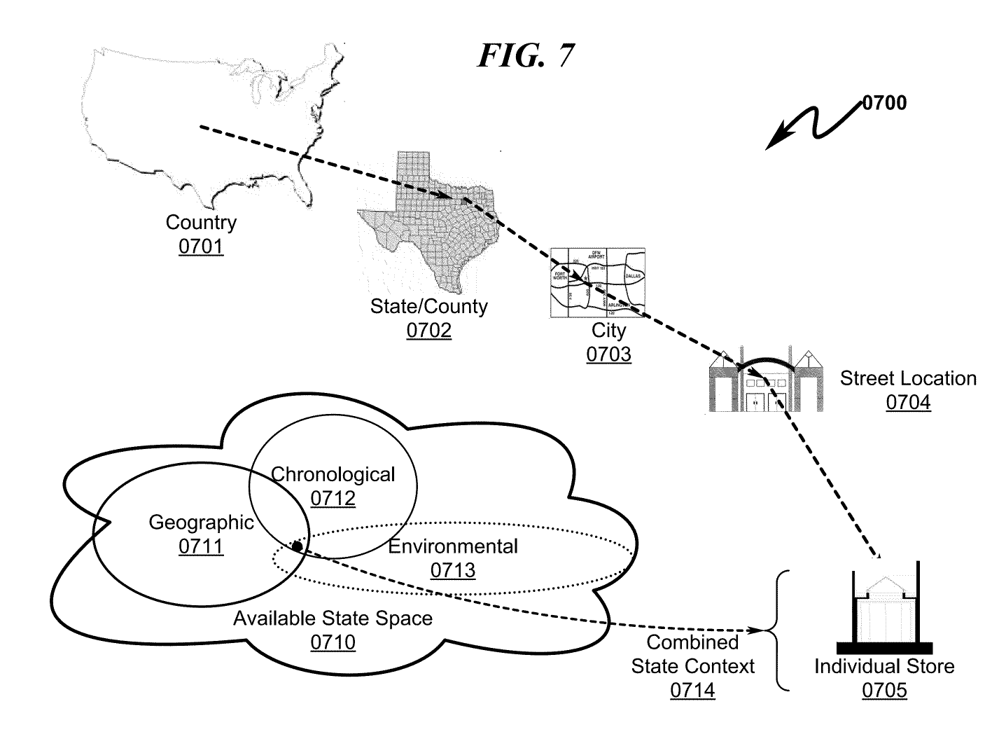

An exemplary depiction of this advertising space fracturing is depicted in FIG. 7 (0700), wherein a geographic fracturing may occur with respect to country (0701), state/county (0702), city (0703), street location (0704), and individual retail store (0705).

As illustrated, the entire available state space map (0710) may be subdivided into various types of advertising space vectors (0711, 0712, 0713) whose intersection represents the targeted combined state context (0714).

As mentioned elsewhere, the monetary rate at which the advertising space is sold may vary based a wide variety of factors, such as whether the advertising state space is exclusive to the advertiser (it could potentially be shared in time/space/etc.), the specificity at which the targeted MCU is identified (household income, previous purchase history, etc.), the scope of the advertising (geographic range, time range, etc.), and whether the advertising results in a product purchase, etc.

### Competitive Advertising Auctions (0800)

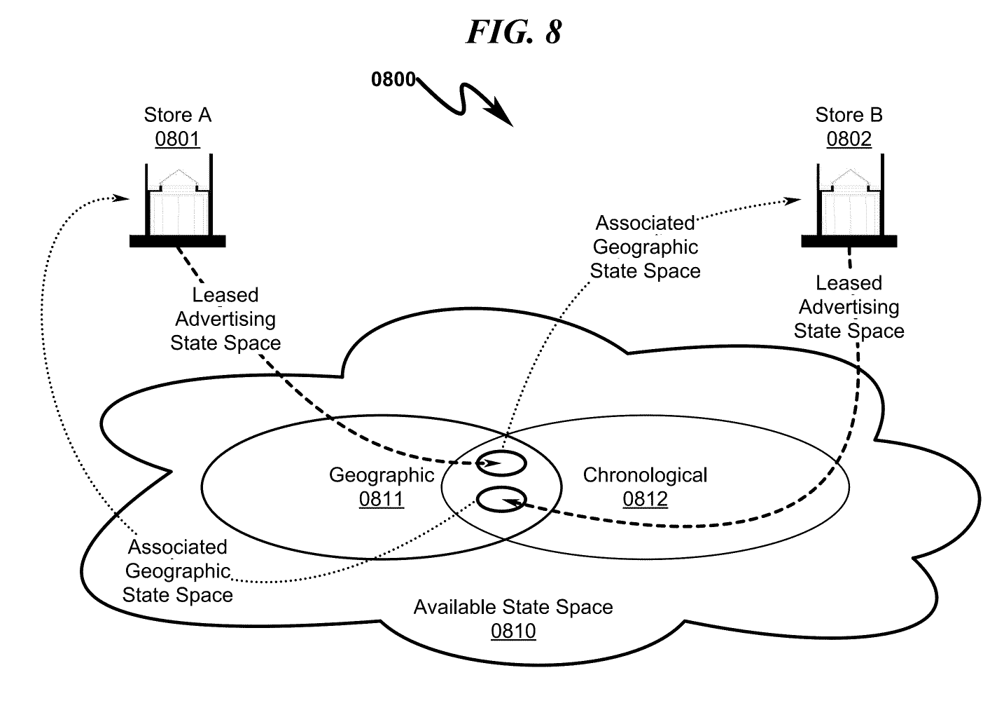

As generally illustrated in FIG. 8 (0800), the present invention anticipates that state spaces tied to a particular retail establishment are not necessarily “owned” by that establishment, and may be auctioned off to competitors under some circumstances. In this example, two competing retail stores (0801, 0802) lease advertising state space from a range of available state space leaseholds (0810). Here the state spaces of interest are given as geographic (0811) and chronological (0812), but any state space variable may be used in this context.

In this exemplary context, Store A (0801) leases advertising state space incorporating a chronological component (for example, “Saturdays and Sundays”) and a geographic component that includes the associated geographic state space identifying Store B (0802). Thus, entry of the MCD into the geographic area of Store B (0802) on “Saturdays and Sundays” will trigger Store A (0801) advertising to the MCD. The diagram indicates that Store B (0802) may reciprocate and advertise in Store A (0801) geographic area using some other geographic/chronological state combination (or some other combination of state variables). Bidding for this competitive advertising state space leaseholds ensures that the market will gravitate towards a steady state of mutually competitive advertising.

Details of this mutually competitive advertising methodology are described later in this document. It should be noted here that it is possible for Store A (0801) and Store B (0802) to lease the SAME state space in this advertising model. Pricing for this situation may vary based on the fact that if Store A (0801) wishes to invade Store B (0802) advertising state space, then the cost to Store A (0801) would increase. Conversely, if Store B (0802) wishes to “lock down” their advertising state space in an exclusive arrangement, this advertising state space is obviously more valuable than if the state space were available for shared or common advertising.

### State Tracking Processor (STP) Embodiments

While the present invention anticipates that many embodiments of the state tracking processor (STP) are possible, several implementations are currently preferred, including the following:
The STP can be implemented as an active software application (AP) on the MCD and continuously monitor the state of the MCD, including keyboard activity, phone activity, Internet traffic, and geolocation. This and other state information can be relayed to the LMC for processing. This form of implementation provides for the most dynamic form of interaction between the LMC and the MCU, and permits a wide variety of MCU states to trigger interactions with advertisers.
The STP may act in the form of a “polled” application that is triggered by the LMC based on a variety of events, such as time, geolocation, advertiser interest, etc.

The STP may be manually activated as an application on the MCD.
The STP may be activated as an application associated with a website accessed by the MCU on the MCD.

One skilled in the art will recognize that this list is non-exhaustive and only illustrative of a wide variety of possible STP implementation methodologies.

### Exemplary State Matching Criterion

The present invention utilizes a broad definition of the term “state” as it applies to the COS/MCD/MCU. However, the following state examples may give a flavor of the state options possible in some applications:
geospatial GPS location of the MCD;
current weather conditions at the current geospatial GPS location of the MCD;
current holiday-of-year; current season-of-year; current month-of-year; current day-of-week; current time-of-day;
physical proximity to a given advertiser;
minimum path to a given advertiser;
travel time to a given advertiser;
geo-spatial path taken by the MCU;
retail establishments visited by the MCU;
time duration spent by the MCU in retail establishments visited by the MCU;
previous purchases made by the MCU;
previous purchase patterns of the MCU;
purchase inquiries made by the MCU;
responses by the MCU to previous PUSH advertising;
correlations between MCU and their social media contacts;
preferences defined by the MCU;
profile characteristics of the MCU;

While the above states are merely exemplary of those anticipated, they provide a powerful capability for advertisers to narrowly target their advertising base and also permit the advertising to be customized for the individual consumer as described below.

### Customized Targeted Advertising

Since a given advertiser wishing to communicate with the MCU can target only MCUs having a given “state”, it is possible to narrowly tailor advertising to a given MCU and thus potentially gain sales where a broadcast form of advertising would not necessarily be effective. For example, a MCU traveling to a home improvement center might be prompted with spontaneous advertising on their mobile device once entering a given home center as to current sales or promotions. This advertising might change based on the time of day or season of the year. Tracking of the MCU within the store might be used to trigger specific advertising based on the store section (e.g., “landscape timbers now on sale in the garden department”). The travel path taken by the MCU within the store and as well to other stores and the time spent within each store may also be used to prompt specific advertising to target the consumer. For example, prompts such as “Didn't find the building supplies you wanted at THE HOME DEPOT? Try ACME HARDWARE STORE, we stock EVERYTHING!”

In some circumstances the PUSH advertising can be targeted towards migrating the MCU to another purchasing decision. For example, if the MCU state is determined to be a movie theater, a possible PUSH advertisement as the MCU leaves the theater might be “Hungry after the movie? Why not try a juicy burger at JOE'S BURGER, just one block away from MID-TOWN MOVIE THEATER.” If path linkages indicated a previous path to a restaurant BEFORE entering the movie theater, the advertising prompt might change to “How about an after-movie desert? Ice cream cones are now on special at JILL'S ICE CREAM SHOPPE, just a block from your location!”

The use of environmental states may also be incorporated into these scenarios. For example, if the current environment state is SUMMER and the MCU has visited a home improvement center garden center, passing a fast food establishment on the way to the MCU's home might prompt the advertisement “Large COLD soft drinks are FREE with any burger purchase!” This shows how linkages to potential PUSH advertising may be triggered on a wide variety of state conditions that may be correlated to form a high probability of consumer purchase.

### In-Store Shopping Assistance (0900)

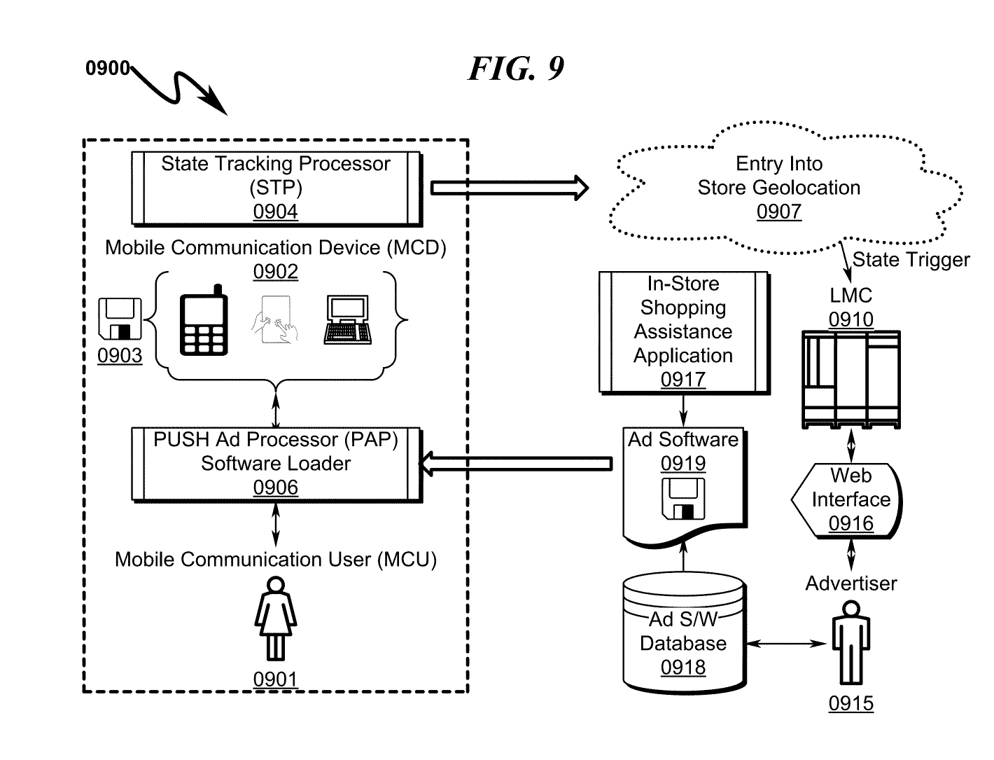

The present invention anticipates that the integration of voice-driven MCU states may be used in some applications to provide in-store shopping assistance. As generally illustrated in FIG. 9 (0900), a MCU (0901) interacting with a MCD (0902) under control of software (0903) provides state tracking information (0904) that will note entry into a store geolocation (0907). This state transition trigger information will be transmitted to the LMC (0910) that interfaces with the store advertiser (0915) via a web interface (0916). This interaction permits definition of an in-store shopping assistance software application (0917) that is part of an advertising software database (0918). This ad software (0919) is then triggered for loading into the PUSH advertising processor (PAP) (0906) for presentation to and interaction with the MCU (0901).

While a variety of application contexts exists for this system embodiment, some preferred contexts incorporate the use of voice commands that would permit a MCU (0901) to request information on certain products and/or services and then the in-store shopping assistance application (0917) would be triggered to address these requests in a tailored fashion. For example, in a grocery store, the MCU might verbally indicate what items constitute the shopping list and the MCD would interact with the MCU to optimize the grocery store route for optimally reduced shopping time. This assistance might also involve historical data to initiate prompts such as “the T-bone steaks you often purchase are now on sale” and the like.

Within other contexts, the in-store shopping assistance application may have “expert” knowledge of product locations within a store and permit the MCU to be directed specifically to a given area of interest. It is anticipated that this in-store shopping application (0917) may incorporate video to permit identification of particular items of interest. For example, shopping at a home improvement center might initiate a MCU request such as “I need a 1/2-inch galvanized pipe right-angle” and responses from the in-store shopping assistance application (0917) such as “We have 32 of these in stock, on aisle 5, just ahead on your right” followed by a picture of the desired item in the context of its current store shelving.

### Store Checkout Integration (1000)

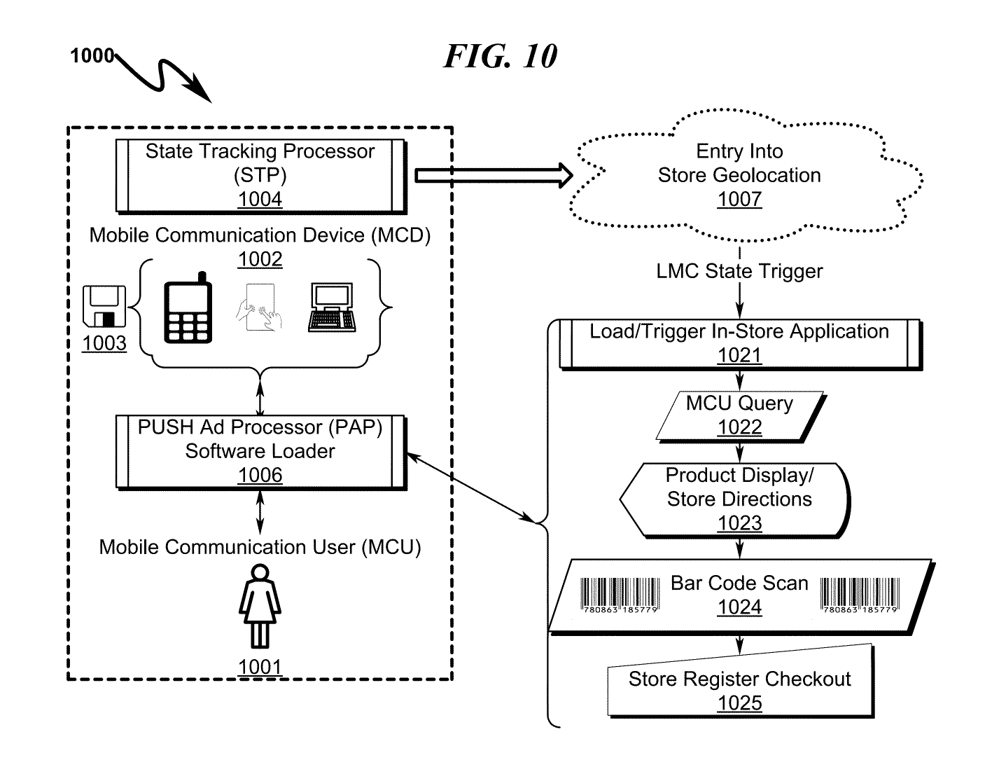

As generally illustrated in FIG. 10 (1000), the present invention anticipates that the in-store shopping assistance application (1021) may incorporate both MCU query functionality (1022), product display and/or store directions (1023), and bar-code scanning (1024) to permit the MCU to scan products for checkout (1025) to further streamline the checkout line process and further optimize the overall shopping experience. Integration with electronic payment systems using Internet-based financial transaction processing is also anticipated within this application context.

### Real-Time Advertising Solicitation System (1100)

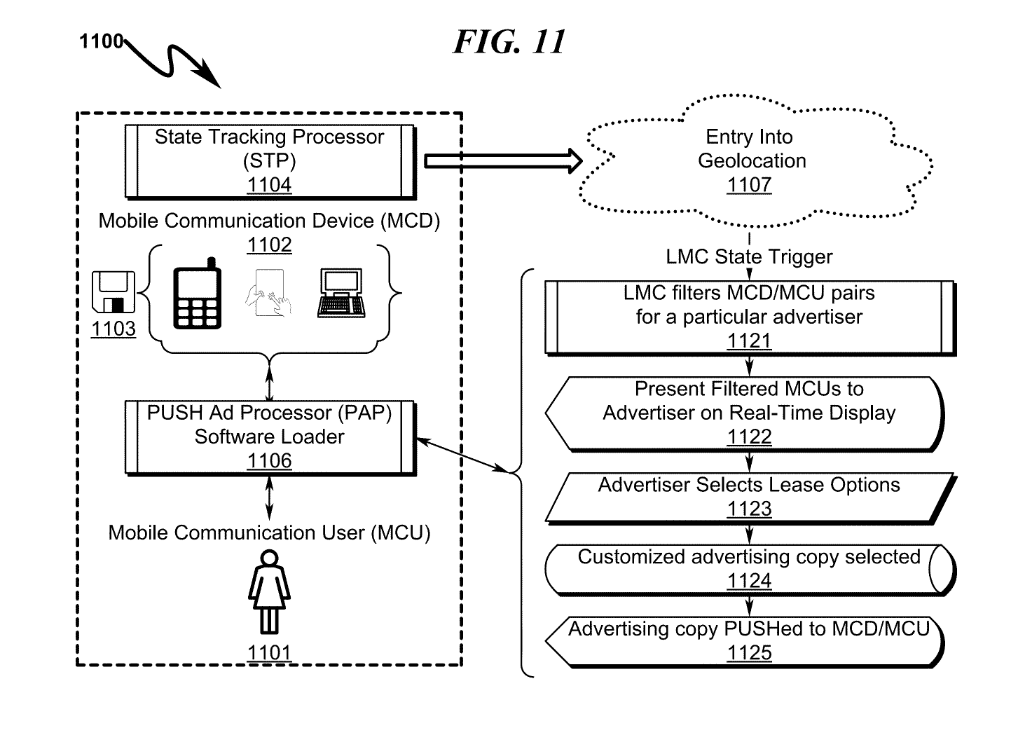

In some preferred embodiments the system may be augmented with a real-time advertiser interface as generally illustrated in FIG. 11 (1100). In this application context, once the MCU (1101)/MCD (1102) enters a specific geolocation (1107), a LMC state trigger event is activated that permits the LMC to filter (1121) MCD/MCU pairs based on proximity to a potential advertiser. A real-time advertiser display (1122) of the MCD/MCU pairs is displayed to illustrate to the advertiser the potential for sales in the current area at a given time. The advertiser may then select an advertising lease (1123) for some or all of the MCD/MCU pairs for the purposes of PUSHing advertising to the selected subset of the filtered pairs. Once the lease options are selected, customized advertising copy is selected (1124) and then PUSHed (1125) to the PAP (1106) operating in conjunction with the MCD (1102).

A key feature of this type of virtual advertising is that is both dynamic and knowledge-based. The advertiser has a real-time view of the “state” of all possible MCD/MCU pairs that have been filtered by the LMC, allowing profiles of potential customers to be displayed/selected in real-time and advertising tailored to these customers to be generated dynamically. Based on advertiser promotions and the like these tailored advertising efforts can be individually customized to the MCU and thus increase advertiser-MCU bonding and customer loyalty.

### Exemplary Real-Time Advertising Solicitation Method (1200)

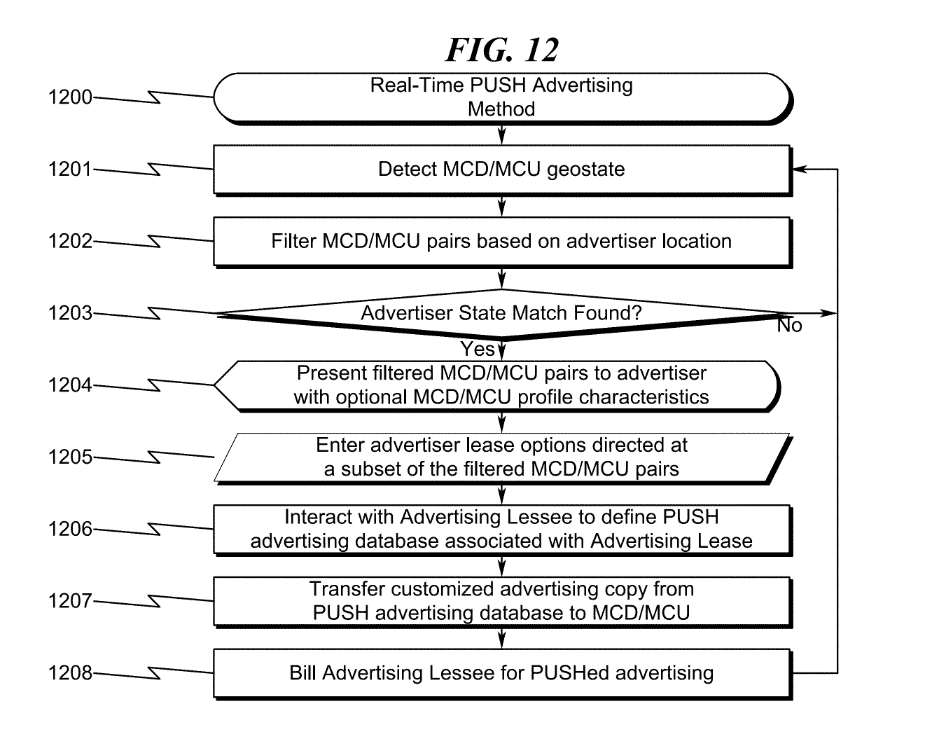

The present invention in a method embodiment applied to real-time advertising may be generally described by the flowchart of FIG. 12 (1200), wherein the real-time advertising method comprises the following steps:
(1) detecting the MCD/MCU geostate (1201);
(2) filtering the MCD/MCU geostate information based on potential advertiser location (1202);
(3) determining if a state match to potential advertisers has been found, and if not, proceeding to step (1) (1203);
(4) presenting the filtered MCD/MCU state pairs to an advertiser with optional MCD/MCU profile characteristics (1204);
(5) allowing the advertiser to lease advertising options directed at a subset of the filtered MCD/MCU pairs (1205);
(6) interacting with the advertising lessee to define a PUSH advertising database associated with the advertising lease (1206);
(7) transferring customized advertising copy from the PUSH advertising database to the MCD/MCU (1207); and
(8) billing the advertising lessee for the PUSHed advertising (1208);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Note that within this exemplary method embodiment the advertising lessee may opt for the distribution of canned advertising from the PUSH advertising database or in some cases automated dissemination of advertising based on certain state criterion (number of potential customers, returning customers, calendar events, etc.). As with other embodiments of the invention, this preferred exemplary embodiment anticipates that payment of the advertising lease may incorporate a surcharge for advertising that actually results in a sale by the advertiser to the MCU.

### Competitive Advertising Solicitation System (1300)

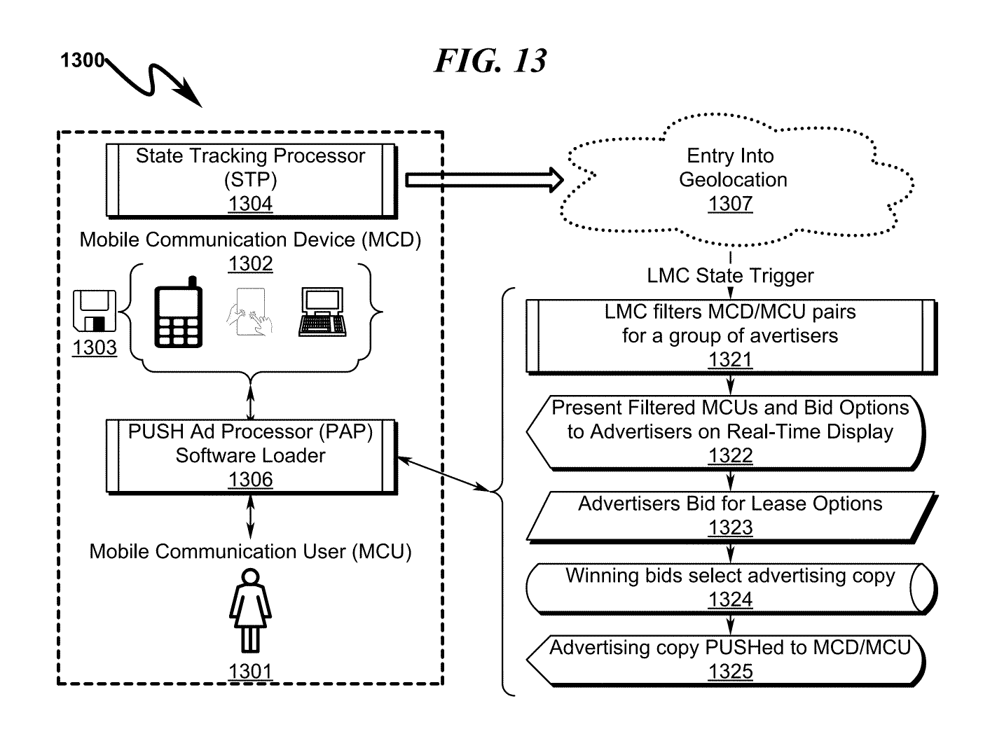

In some preferred embodiments the system may be augmented with a competitive advertiser interface as generally illustrated in FIG. 13 (1300). In this application context, once the MCU (1301)/MCD (1302) enters a specific geolocation (1307), a LMC state trigger event is activated that permits the LMC to filter (1321) MCD/MCU pairs based on proximity to a group of potential advertisers. A real-time advertiser display (1322) of the potential MCD/MCU pairs is displayed on various advertiser display interfaces to illustrate to the advertisers the potential for sales in the current area at a given time. The advertisers may then bid for selected advertising lease (1323) and compete against one another for access to some or all of the MCD/MCU pairs for the purposes of PUSHing advertising to the selected subset of the filtered pairs. Once the winning advertising lease bidders are determined, customized advertising copy is selected (1324) by the winning advertisers and then PUSHed (1325) to the PAP (1306) operating in conjunction with the MCD (1302).

A key feature of this type of virtual advertising is that is both dynamic and knowledge-based. The advertisers have a real-time view of the “state” of all possible MCD/MCU pairs that have been filtered by the LMC as well as other potential competing advertisers, allowing profiles of potential customers and/or competitors to be displayed/selected in real-time and advertising tailored to these customers to be generated dynamically. This advertising model permits competitive advertising bids by advertisers to “steer” customers away from a competing establishment, and thus permit a savvy advertiser to gain market share in a market of limited resource consumers. For example, state information collected about a MCU entering a home improvement center might be used to bid a competitive advertisement from a competitive retailer to offer discounts or other promotions at a lower price. This spatial granularity might include, for example, displays PUSHed to the PAP (1306) that include products at a competing store that are displayed on the MCD (1302) while the MCU walks the aisles of a retail establishment. For example, it might be possible to view prices and stock via video on the MCD of a competing store while walking through the current establishment. This type of competitive marketing might include aisle-by-aisle or product-by-product linkages between competing stores to allow actual comparisons of like items using the MCD (1302) as the display presentation and browsing interface.

### Exemplary Competitive Advertising Solicitation Method (1400)

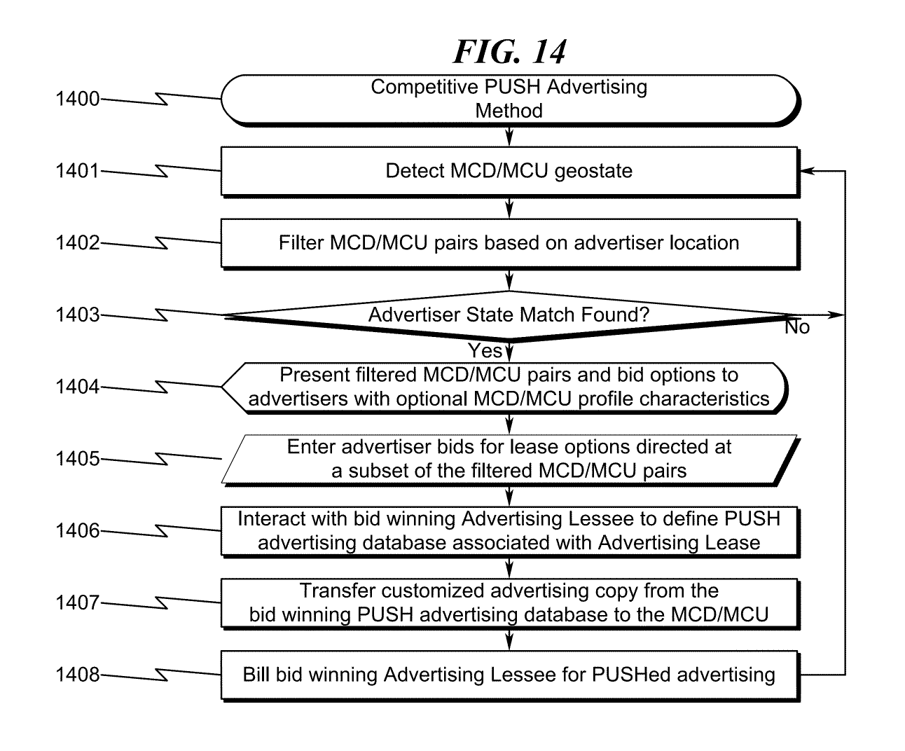

The present invention in a method embodiment applied to competitive advertising may be generally described by the flowchart of FIG. 14 (1400), wherein the competitive advertising method comprises the following steps:
(1) detecting the MCD/MCU geostate (1401);
(2) filtering the MCD/MCU geostate information based on potential advertiser locations (1402);
(3) determining if a state match to potential advertisers has been found, and if not, proceeding to step (1) (1403);
(4) presenting the filtered MCD/MCU state pairs and lease bidding options to a group of advertisers with optional MCD/MCU profile characteristics and advertiser characteristics (1404);
(5) entering advertiser bids for lease advertising options directed at a subset of the filtered MCD/MCU pairs (1405);
(6) interacting with the bid winning advertising lessee to define a PUSH advertising database associated with the advertising lease (1406);
(7) transferring customized advertising copy from the bid winning PUSH advertising database to the MCD/MCU (1407); and
(8) billing the bid winning advertising lessee for the PUSHed advertising (1408);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Note that within this exemplary method embodiment the bid winning advertising lessee may opt for the distribution of canned advertising from the PUSH advertising database or in some cases automated dissemination of advertising based on certain state criterion (number of potential customers, returning customers, calendar events, etc.). As with other embodiments of the invention, this preferred exemplary embodiment anticipates that payment of the bid winning advertising lease may incorporate a surcharge for advertising that actually results in a sale by the advertiser to the MCU. Some embodiments of the present invention may permit multiple advertisers to “win” a given non-exclusive and/or overlapping advertising lease, with a corresponding modification of the advertising lease rate associated with the advertising leasehold.

### State History Matching

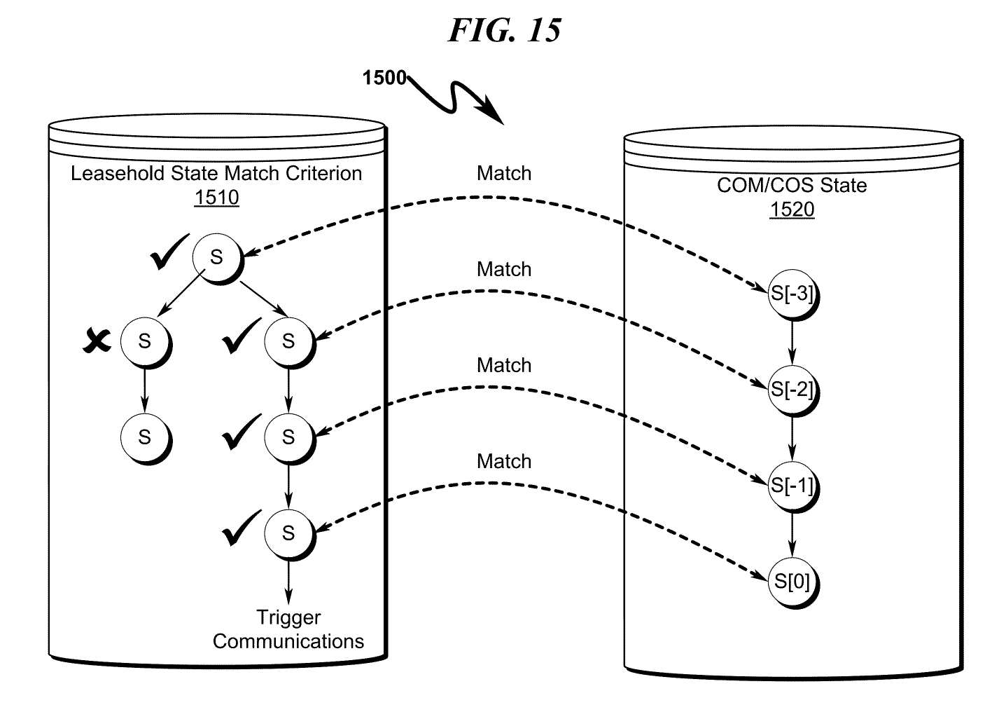

As generally illustrated in FIG. 15 (1500), the present invention in some preferred embodiments may utilize state history matching to trigger communications between the COM and COS. This permits state tree matching criterion in the leasehold state match criterion database (1510) to match historical information (1520) gathered about the COM/COS and stored in the COM or COS state database.

FIG. 15 (1500) illustrates this matching process in action. Matching criterion in the leasehold state match criterion database (1510) may take the form of a state tree having various states that are to be matched and action entities to be triggered upon matching the state criterion. Simple state matching may occur with a single state triggering a corresponding activity such as an advertising event. More complex state tree branches may require a sequence of states to be transitioned, or a set of conditions to be met, before communications is triggered. The COM/COS state database (1520) (symbolically illustrated as a single database that may be divided based on application) maintains state history for the COM/COS and this information can be dynamically compared to the match criterion database to fire appropriate communications (advertising) between the COM and COS.

### Leasehold State Match Criterion Comparison Method (1600)

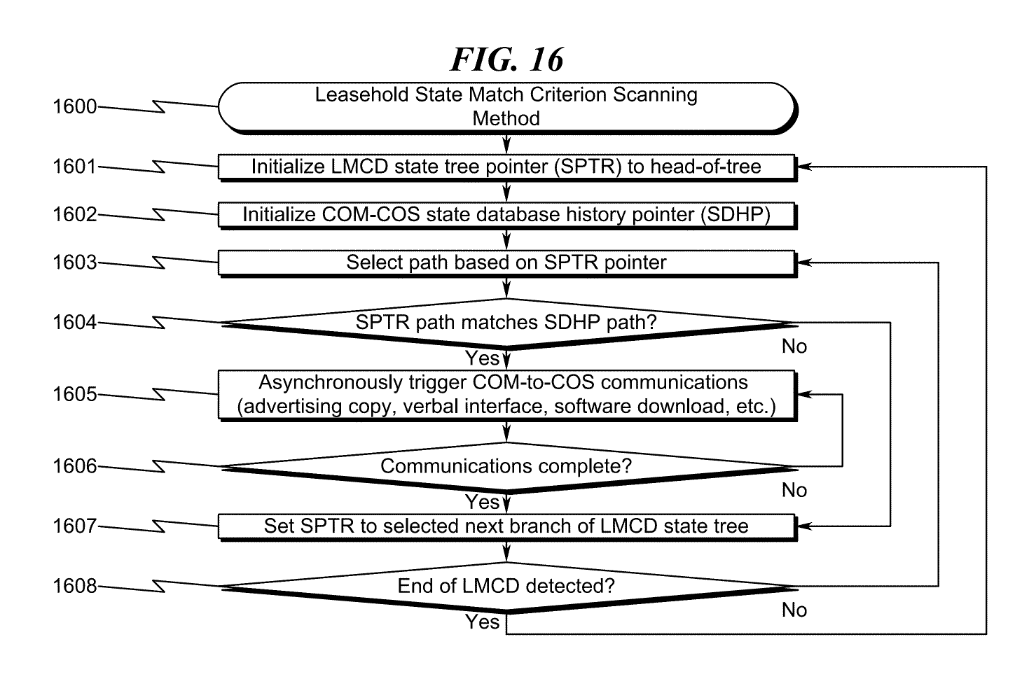

The present invention in a method embodiment applied to matching the leasehold state match criterion database (LMCD) to historical COM/COS state data may be generally described by the flowchart of FIG. 16 (1600), wherein the LSMD comparison method comprises the following steps:
(1) initializing a LMCD state tree pointer (SPTR) to the head-of-tree associated with the LMCD (1601);
(2) initializing a COM-COS state database history pointer (SDHP) to the beginning of the COM-COS history (1602);
(3) selecting a path within the LMCD based on the current value of the SPTR (1603);
(4) determining if the history path along SPTR matches the elements in the SDHP path, and if not, proceeding to step (7) (1604);
(5) asynchronously triggering COM-to-COS communications based on information contained in the LMCD such as advertising copy, software downloads, verbal interface interactions, etc. (1605);
(6) determining of COM-COS communications is complete, and if not, proceeding to step (5) (1606);
(7) setting the LMCD SPTR to select the next branch of the LMCD state tree (1607);
(8) determining if the LMCD has been completely traversed, and if not, proceeding to step (2), otherwise proceeding to step (1) (1608);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Note that within this exemplary method embodiment the COM-COS communication is optimally triggered asynchronously. However, in some embodiments the advertising may be synchronously triggered, especially in situations where advertisers have competitively bid for the privilege of presenting their advertising on a priority basis to the MCU. This synchronous delivery method may include surcharges for associated delivery priorities (high/medium/low/etc.) of the advertising content to the MCD.

### System Summary

The present invention system anticipates a wide variety of variations in the basic theme of construction, but can be generalized as a contextual communication management system comprising:
(a) Leasehold Management Coordinator (LMC);
(b) Leasehold State Match Criterion Database (LMCD);
(c) Communication Master State Database (CMSD);
(d) Communication Slave State Database (CSSD); and
(e) Contextual Communication Manager (CCM);
wherein
the LMC further comprises a user interface that communicates with a Communication Master (COM) and/or a Communication Slave (COS) via a communication network;
the LMC generates and maintains the LMCD in response to inputs from the COM and/or the COS via the user interface;
the LMC defines leasehold states within the LMCD comprising an algebraic combination of state references within the CMSD and/or the CSSD;
the LMC accepts state data from the COM to generate current COM state data within the CMSD;
the LMC accepts state data from the COS to generate current COS state data within the CSSD; and
the LMC compares the leasehold states with the current COM state data extracted from the CMSD and the current COS state data extracted from the CSSD and if the comparison is a match, enables the CCM to affect communication between the COM and the COS.

This general system summary may be augmented by the various elements described herein to produce a wide variety of invention embodiments consistent with this overall design description.

### Method Summary

The present invention method anticipates a wide variety of variations in the basic theme of implementation, but can be generalized as a contextual communication management method, the method operating in conjunction with a contextual communication management system, the system comprising:
(a) Leasehold Management Coordinator (LMC);
(b) Leasehold State Match Criterion Database (LMCD);
(c) Communication Master State Database (CMSD);
(d) Communication Slave State Database (CSSD); and
(e) Contextual Communication Manager (CCM);
wherein the method comprises the steps of:
(1) creating and maintaining the Leasehold State Match Criterion Database (LMCD) that defines matching criterion for state references associated with a Communication Master (COM) and a Communication Slave (COS);
(2) receiving current state information from the COM and storing the current COM state information in the CMSD;
(3) receiving current state information from the COS and storing the current COS state information in the CSSD;
(4) determining if there is a state match found between the matching criterion state references and the stored states in the CMSD and/or the CSSD;
(5) if the state match is not found, proceeding to the step (1);
(6) triggering a communication event between the COM and the COS using the CCM and proceeding to step (1).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the state references are selected from a group comprising:
(1) geographic;
(2) chronological;
(3) travel;
(4) history;
(5) environmental;
(6) economic;
(7) cluster;
(8) response;
(9) inquiry;
(10) purchase;
(11) event; and
(12) profile.
An embodiment wherein the COM comprises an advertiser.
An embodiment wherein the communication between the COM and the COS comprises advertising from the COM to the COS.
An embodiment wherein the communication between the COM and the COS comprises a solicitation from the COS to the COM.
An embodiment wherein the COM may interrogate the CSSD through the user interface via the CCM.
An embodiment wherein the COS may interrogate the CMSD through the user interface via the CCM.
An embodiment wherein the COS is embodied in computerized hardware selected from a group consisting of a mobile phone, smartphone, tablet computer, laptop computer, and automobile computer.
An embodiment wherein the communication network comprises the Internet.
An embodiment wherein the user interface comprises an HTML-based web interface.

One skilled in the art will recognize that other embodiments are possible based on combinations of elements taught within the above invention description.

### Alternative System Summary

An alternative present invention system embodiment anticipates a wide variety of variations in the basic theme of construction, but can be generalized as a contextual communication management system comprising:
(a) Leasehold Management Coordinator (LMC);
(b) Available Advertising States Database (AASD);
(c) Leased Advertising States Database (LASD);
(d) State Tracking Processor (STP);
(e) Advertising Copy Database (ACD); and
(f) PUSH Advertising Processor (PAP);
wherein
the LMC generates and maintains the AASD that comprises the set of available advertising states (AAS) associated with a mobile communication device (MCD) operated by a mobile communication user (MCU);
the LMC generates the LASD comprising a subset of states within the AASD that are leased to an advertising lessee;
the STP communicates the Current Mobile State (CMS) of the MCD and the MCU to the LMC through a communication network;
the LMC compares the CMS to advertising states stored within the LASD, and if a state match is found, the LMC extracts Targeted Advertising Data (TAD) from the ACD and transfers the TAD to the PAP through the communication network; and
the PAP presents the TAD to the MCU via the MCD.

This general system summary may be augmented by the various elements described herein to produce a wide variety of invention embodiments consistent with this overall design description.

### Alternative Method Summary

An alternative present invention method embodiment anticipates a wide variety of variations in the basic theme of implementation, but can be generalized as a contextual communication management method, the method operating in conjunction with a contextual communication management system, the system comprising:
(a) Leasehold Management Coordinator (LMC);
(b) Available Advertising States Database (AASD);
(c) Leased Advertising States Database (LASD);
(d) State Tracking Processor (STP);
(e) Advertising Copy Database (ACD); and
(f) PUSH Advertising Processor (PAP);
wherein the method comprises the steps of:
(1) generating and maintaining with the LMC the AASD that comprises the set of available advertising states (AAS) associated with a mobile communication device (MCD) operated by a mobile communication user (MCU);
(2) generating with the LMC the LASD that comprises a subset of states within the AASD that are leased to an advertising lessee;
(3) communicating with the STP the Current Mobile State (CMS) of the MCD and the MCU to the LMC through a communication network;
(4) comparing with the LMC the CMS to advertising states stored within the LASD, and if a state match is found, extracting with the LMC Targeted Advertising Data (TAD) from the ACD and transferring the TAD to the PAP through the communication network; and
(5) presenting the TAD using the PAP to the MCU via the MCD.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Alternative System/Method Variations

The present invention alternative embodiment anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the AAS is selected from a group comprising:
(1) geographic;
(2) chronological;
(3) travel;
(4) history;
(5) environmental;
(6) economic;
(7) cluster;
(8) response;
(9) inquiry;
(10) purchase;
(11) event; and
(12) profile.
An embodiment wherein the advertising lessee comprises a plethora of advertisers.
An embodiment wherein the MCD is embodied in computerized hardware selected from a group consisting of a mobile phone, smartphone, tablet computer, laptop computer, and automobile computer.
An embodiment wherein the communication network comprises the Internet.
An embodiment wherein the STP tracks the GPS location of the MCD.
An embodiment wherein the STP tracks the GPS path of the MCD and the associated time at each location along the GPS path.
An embodiment wherein the STP tracks the proximity of the MCD to a database of retailers maintained by the LMC.
An embodiment wherein the LMC triggers the TAD in response to the proximity of the MCD to a retailer location retrieved from a retailer information database maintained by the LMC.
An embodiment wherein the LMC triggers the TAD in response to the time duration of the MCD within a retailer location retrieved from a retailer information database maintained by the LMC.

One skilled in the art will recognize that other embodiments are possible based on combinations of elements taught within the above invention description.

### Generalized Computer Usable Medium

As generally illustrated herein, the system embodiments of the present invention can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention.

### CONCLUSION

A contextual communication management system/method that coordinates the dissemination of information to/from a mobile communication device (MCD) and the associated mobile communication user (MCU) has been disclosed. The system/method allows the state context of a given MCD and its MCU to be used to direct communications with the MCD based on a wide variety of state parameters including but not limited to current geospatial location, geospatial path, path chronology, third party geo-temporal leaseholds, etc. In some preferred embodiments this contextual communication permits targeted advertising to be “pushed” to a MCD in response to a function of the real-time geospatial location and current/past known states of the MCU. A Leasehold Management Coordinator (LMC) permits targeted bi-directional third-party interactions with the MCD based on advertising “leases” of virtual MCD geo-space/time and associated MCU state/context pools.

What is claimed is:

1. A contextual communication management system comprising:
(a) Leasehold Management Coordinator (LMC);
(b) Leasehold State Match Criterion Database (LMCD);
(c) Communication Master State Database (CMSD);
(d) Communication Slave State Database (CSSD); and
(e) Contextual Communication Manager (CCM);
wherein
said LMC further comprises a user interface that communicates with a Communication Master (COM) and/or a Communication Slave (COS) via a communication network;
said LMC generates and maintains said LMCD in response to inputs from said COM and/or said COS via said user interface;
said LMC defines leasehold states within said LMCD comprising an algebraic combination of state references within said CMSD and/or said CSSD;
said LMC accepts state data from said COM to generate current COM state data within said CMSD;
said LMC accepts state data from said COS to generate current COS state data within said CSSD; and
said LMC compares said leasehold states with said current COM state data extracted from said CMSD and said current COS state data extracted from said CSSD and if said comparison is a match, enables said CCM to affect communication between said COM and said COS.

2. The contextual communication management system of claim 1 wherein said state references are selected from a group comprising:
(1) geographic;
(2) chronological;
(3) travel;
(4) history;
(5) environmental;
(6) economic;
(7) cluster;
(8) response;
(9) inquiry;
(10) purchase;
(11) event; and
(12) profile.

3. The contextual communication management system of claim 1 wherein said COM comprises an advertiser.

4. The contextual communication management system of claim 1 wherein said communication between said COM and said COS comprises advertising from said COM to said COS.

5. The contextual communication management system of claim 1 wherein said communication between said COM and said COS comprises a solicitation from said COS to said COM.

6. The contextual communication management system of claim 1 wherein said COM may interrogate said CSSD through said user interface via said CCM.

7. The contextual communication management system of claim 1 wherein said COS may interrogate said CMSD through said user interface via said CCM.

8. The contextual communication management system of claim 1 wherein said COS is embodied in computerized hardware selected from a group consisting of a mobile phone, smartphone, tablet computer, laptop computer, and automobile computer.

9. A contextual communication management method, said method operating in conjunction with a contextual communication management system, said system comprising:
(a) Leasehold Management Coordinator (LMC);
(b) Leasehold State Match Criterion Database (LMCD);
(c) Communication Master State Database (CMSD);
(d) Communication Slave State Database (CSSD); and
(e) Contextual Communication Manager (CCM);
wherein said method comprises the steps of:
(1) creating and maintaining said Leasehold State Match Criterion Database (LMCD) that defines matching criterion for state references associated with a Communication Master (COM) and a Communication Slave (COS);
(2) receiving current state information from said COM and storing said current COM state information in said CMSD;
(3) receiving current state information from said COS and storing said current COS state information in said CSSD;
(4) determining if there is a state match found between said matching criterion state references and the stored states in said CMSD and/or said CSSD;
(5) if said state match is not found, proceeding to said step (1);
(6) triggering a communication event between said COM and said COS using said CCM and proceeding to said step (1).

10. The contextual communication management method of claim 9 wherein said state references are selected from a group comprising:
(1) geographic;
(2) chronological;
(3) travel;
(4) history;
(5) environmental;
(6) economic;
(7) cluster;
(8) response;
(9) inquiry;
(10) purchase;
(11) event; and
(12) profile.

11. The contextual communication management method of claim 9 wherein said COM comprises an advertiser.

9. The contextual communication management method of claim 9 wherein said communication between said COM and said COS comprises advertising from said COM to said COS.

13. The contextual communication management method of claim 9 wherein said communication between said COM and said COS comprises a solicitation from said COS to said COM.

14. The contextual communication management method of claim 9 wherein said COM may interrogate said CSSD through said user interface via said CCM.

15. The contextual communication management method of claim 9 wherein said COS may interrogate said CMSD through said user interface via said CCM.

16. The contextual communication management method of claim 9 wherein said COS is embodied in computerized hardware selected from a group consisting of a mobile phone, smartphone, tablet computer, laptop computer, and automobile computer.

17. A contextual communication management system comprising:
(a) Leasehold Management Coordinator (LMC);
(b) Available Advertising States Database (AASD);
(c) Leased Advertising States Database (LASD);
(d) State Tracking Processor (STP);
(e) Advertising Copy Database (ACD); and
(f) PUSH Advertising Processor (PAP);
wherein
said LMC generates and maintains said AASD that comprises the set of available advertising states (AAS) associated with a mobile communication device (MCD) operated by a mobile communication user (MCU);
said LMC generates said LASD comprising a subset of states within said AASD that are leased to an advertising lessee;
said STP communicates the Current Mobile State (CMS) of said MCD and said MCU to said LMC through a communication network;
said LMC compares the CMS to advertising states stored within said LASD, and if a state match is found, said LMC extracts Targeted Advertising Data (TAD) from said ACD and transfers said TAD to said PAP through said communication network; and
said PAP presents said TAD to said MCU via said MCD.

18. The contextual communication management system of claim 17 wherein said AAS is selected from a group comprising:
(1) geographic;
(2) chronological;
(3) travel;
(4) history;
(5) environmental;
(6) economic;
(7) cluster;
(8) response;
(9) inquiry;
(10) purchase;
(11) event; and
(12) profile.

19. The contextual communication management system of claim 17 wherein said MCD is embodied in computerized hardware selected from a group consisting of a mobile phone, smartphone, tablet computer, laptop computer, and automobile computer.

20. The contextual communication management system of claim 17 wherein said STP tracks the GPS location of said MCD.

21. The contextual communication management system of claim 17 wherein said STP tracks the GPS path of said MCD and the associated time at each location along said GPS path.

22. The contextual communication management system of claim 17 wherein said STP tracks the proximity of said MCD to a database of retailers maintained by said LMC.

23. The contextual communication management system of claim 17 wherein said LMC triggers said TAD in response to the proximity of said MCD to a retailer location retrieved from a retailer information database maintained by said LMC.

24. The contextual communication management system of claim 17 wherein said LMC triggers said TAD in response to the time duration of said MCD within a retailer location retrieved from a retailer information database maintained by said LMC.

25. A contextual communication management method, said method operating in conjunction with a contextual communication management system, said system comprising:
(a) Leasehold Management Coordinator (LMC);
(b) Available Advertising States Database (AASD);
(c) Leased Advertising States Database (LASD);
(d) State Tracking Processor (STP);
(e) Advertising Copy Database (ACD); and
(f) PUSH Advertising Processor (PAP);
wherein said method comprises the steps of:
(1) generating and maintaining with said LMC said AASD that comprises the set of available advertising states (AAS) associated with a mobile communication device (MCD) operated by a mobile communication user (MCU);
(2) generating with said LMC said LASD that comprises a subset of states within said AASD that are leased to an advertising lessee;
(3) communicating with said STP the Current Mobile State (CMS) of said MCD and said MCU to said LMC through a communication network;
(4) comparing with said LMC the CMS to advertising states stored within said LASD, and if a state match is found, extracting with said LMC Targeted Advertising Data (TAD) from said ACD and transferring said TAD to said PAP through said communication network; and
(5) presenting said TAD using said PAP to said MCU via said MCD.

26. The contextual communication management method of claim 25 wherein said AAS is selected from a group comprising:
(1) geographic;
(2) chronological;
(3) travel;
(4) history;
(5) environmental;
(6) economic;
(7) cluster;
(8) response;
(9) inquiry;
(10) purchase;
(11) event; and
(12) profile.

27. The contextual communication management method of claim 25 wherein said MCD is embodied in computerized hardware selected from a group consisting of a mobile phone, smartphone, tablet computer, laptop computer, and automobile computer.

28. The contextual communication management method of claim 25 wherein said STP tracks the GPS location of said MCD.

29. The contextual communication management method of claim 25 wherein said STP tracks the GPS path of said MCD and the associated time at each location along said GPS path.

30. The contextual communication management method of claim 25 wherein said STP tracks the proximity of said MCD to a database of retailers maintained by said LMC.

31. The contextual communication management method of claim 25 wherein said LMC triggers said TAD in response to the proximity of said MCD to a retailer location retrieved from a retailer information database maintained by said LMC.

32. The contextual communication management method of claim 25 wherein said LMC triggers said TAD in response to the time duration of said MCD within a retailer location retrieved from a retailer information database maintained by said LMC.
